(19) United States
(12) Patent Application Publication
(10) Pub. No.: US 2007/0041189 A1
(43) Pub. Date: Feb. 22, 2007

(54) Decorative lighting attachment process

(76) Inventors: Glenn M. Mchinnis, Lutz, FL (US); John Franklin Coyne, Mechanicsburg, PA (US)

Correspondence Address: Glenn M. Mchinnis, 4902 Mirabella Place, Lutz, FL, 33558, US

(21) Appl. No.: 11/208,180

(22) Filed: Aug. 22, 2005

(51) Int. Cl. F21S 6/00; F21S 13/14

(52) U.S. Cl. 362/252; 362/249; 362/123

(57) ABSTRACT

The present invention provides devices and methods which allow rapid and convenient mounting, aligning and patterning strings of decorative light bulbs and Light Emitting Diodes (LEDs) on flat surfaces, curved surfaces, generally cylindrical structures such as the trunks of outdoor and indoor trees, branching objects such as branching tree structures and the like. The included devices would be used as part of a decorative lighting attachment process, which can include 1 or a plurality of flexible holiday decorative lighting mounting strips and various types of mounting devices as required. Light covers might be used to cover and darken lights that disrupt patterns. A single decorative lighting attachment strip can be used to position and align lights on a roughly cylindrical object. A multitude of decorative lighting attachment strips may be used to allow wrapping strings of decorative lights about a roughly cylindrical or branched object in a decorative pattern, which can encircle the entire circumference of the object or a portion thereof. A multitude of decorative lighting strips may be used to affix strings of decorative lights to flat or curved surfaces.

### BACKGROUND OF THE INVENTION

1. Field of the Invention

The submitted invention relates generally to the attachment of decorative lighting to flat surfaces such as walls, roofs, doors and fences, cylindrical objects such as poles, trees which are in reality roughly cylindrical objects that can be of a varying circumference with a curved axis and branched objects such as forked trees.

2. Description of the Related Art

It is traditional to use commercially available strings of decorative lights during the Christmas holiday season as well as other holidays. Decorative lights (clear or colored) are also installed permanently in many outdoor genres such as outdoor restaurants and parks on a year round basis. These decorative strings consist of individual interconnected lights or LEDs, having plug-type connectors on both ends. A multitude of strings can be connected in series or parallel circuits. Presently, the only practical means to decorate large flat surfaces is to utilize lighting nets or install individual mounting points as required. The primary method of decorating roughly cylindrical objects such as trees is to drape lights around the object in a helical fashion. Wrapping decorative lights in a helical fashion requires the user to pass a light string around and around the object being decorated and is difficult and dangerous when working on a ladder. Most decorative lights are comprised of 2 or more twisted wires and are packaged in a tightly coiled fashion. This results in stretching of the overall string length as the twists tighten and the kinks straighten after the lights are mounted and gravity and solar heating start to impart their effects. This induces an overall stretching and slippage of the decorative light strings as the typical helical wrap depends upon a friction bind between the decorative lighting string and the decorated object. Rope lights are also a popular decorating method. However, few if any decorative lighting attachment methods allow for the inclusion of decorative rope lights.

An improvement that addresses the existing problems of the prior art would be theretofore desirable.

### SUMMARY OF THE INVENTION

The submitted invention in a broad aspect provides devices and methods for rapidly and conveniently designing, installing and removing decorative arrangements of one or a multitude of strings of commercially available light bulb, rope lights, bubble lights, Light Emitting Diodes, EL Wires or any other type of decorative lights on both planar, curved, cylindrical and branched cylindrical surfaces. The included devices may be easily attached and removed from the decorated object or they may remain permanently attached. All of the devices described herein are manufactured from a variety of plastics and nylon. Any desired color can be embedded within the plastic itself. In addition, the devices are finished with a matte or etched finish in order to facilitate painting of the devices to match the color of the object to which they are attached.

A preferred aspect of this submission is the use of decorative lighting attachment strips referred to as attachment spines and alignment combs in conjunction with cylindrical and modified cylindrical objects. Spines are used as lighting string connection points and combs are used as necessary to maintain even and parallel alignment. There are multiple embodiments that are offered for this aspect of the invention.

The simplest embodiment consists of using one or a plurality of alignment combs to ensure constant spacing between parallel rows of decorative lights as they are affixed in a helical fashion to cylindrical, modified cylindrical or branched objects.

### BRIEF DESCRIPTION OF THE DRAWINGS

FIG. 1 is a side view of a tree wrapped in a spiral fashion using 1 decorative lighting alignment comb.

FIG. 2 is a side view of a tree wrapped in a spiral fashion using a plurality of combs.

FIG. 3 is a variation of the tree wrapping method shown in FIG. 2.

FIG. 3A is a 3-dimensional view of the method shown in FIG. 3.

FIG. 3B describes another variation for using a single decorative alignment comb.

FIG. 4 is a side view of a tree wrapped in a spiral fashion with rope lights using a plurality of combs.

FIG. 4A is a 3-dimensional view of the process illustrated in FIG. 4.

FIG. 5 is a rear view of a tree wrapped in a perpendicular fashion using 1 decorative lighting attachment spine.

FIG. 6 is a front view of tree wrapped in a perpendicular fashion using 1 decorative lighting attachment spine.

FIG. 7 is a 3 view drawing of the first style of a decorative lighting attachment spine.

FIG. 7A is a 3 view drawing of a first style of decorative lighting alignment comb.

FIG. 8 is a 3 view drawing of the second style of a decorative lighting attachment spine.

FIG. 8A is a 3 view drawing of the second style of a decorative lighting alignment comb.

FIG. 9 is a 3 view drawing of the third style of a decorative lighting attachment spine.

FIG. 9A is a 3 view drawing of the third style of a decorative lighting alignment comb.

FIG. 10 is a 3 view drawing of the fourth style of a decorative lighting attachment spine.

FIG. 10A is a 3 view drawing of the fourth style of a decorative lighting attachment comb.

FIG. 11 is a 3 view drawing of one half of the divisible or fifth style of decorative lighting attachment spine.

FIG. 11A is a 3 view drawing of the mating clip assembly used to join the 2 halves of the fifth style of decorative lighting attachment spines.

FIG. 11B is a 3 view drawing of the optional cover for the fifth style of decorative lighting attachment spine

FIG. 11C is a 3 view drawing of the decorative lighting comb that is compatible with the fifth style of decorative lighting attachment spine.

FIG. 11D is an exploded end view showing the relationship between the 4 components of a fifth style decorative lighting attachment spine.

FIG. 11E is an end view showing the 4 assembled components of a fifth style decorative lighting attachment spine.

FIG. 12 illustrates methods of attaching decorative lighting spines and combs to objects

FIG. 13 is an isometric view depicting usage of one decorative lighting attachment spine on a cylindrical object.

FIG. 13A is an isometric view highlighting details of lighting attachment to an alignment spine.

FIG. 14 is an isometric drawing illustrating how wiring, cables and mounting straps relate to an attachment spine.

FIG. 14A is an isometric drawing illustrating how the attachment spine cover is used.

FIG. 14B is an isometric drawing illustrating how wiring, cables and mounting straps relate to an alignment comb.

FIG. 15 is an isometric view depicting usage of 2 decorative lighting attachment spines on a cylindrical object.

FIG. 16 is an isometric view depicting usage of a multitude of decorative lighting attachment spines on a cylindrical object

FIG. 16A is an isometric view of a decorated cylindrical object with 2 layers of decorative lights.

FIG. 16B is a transparent isometric drawing of the cylinder depicted in FIG. 16

FIG. 17 is an isometric view depicting another design possibility for decorating cylinders.

FIG. 17A is a detail drawing illustrating an alternative method for accomplish the design depicted in FIG. 17

FIG. 18 is an isometric drawing of a branched tree decorated with the decorative lighting process.

FIG. 18A is a detail drawing illustrating how the first of 2 branched is decorated

FIG. 18B is a detail drawing illustrating how the second and all remaining branches of a plurality of branches would be decorated.

FIG. 19 is an isometric drawing illustrating usage of attachment spines in a horizontal plane.

FIG. 20 is a front view showing spines and combs on a wall

FIG. 21 is a front view showing a design implemented on the spines and combs shown in FIG. 20.

### DETAILED DESCRIPTION OF THE PREFERRED EMBODIMENTS

A new and emerging business profession centers upon the ability to design, implement and install a holiday lighting display for homes and business. The service includes initial installation, removal at season end, warehousing the decorative material between seasons and reapplying the decorations the following season. There are no viable tools to allow easy re-use of a previously applied design.

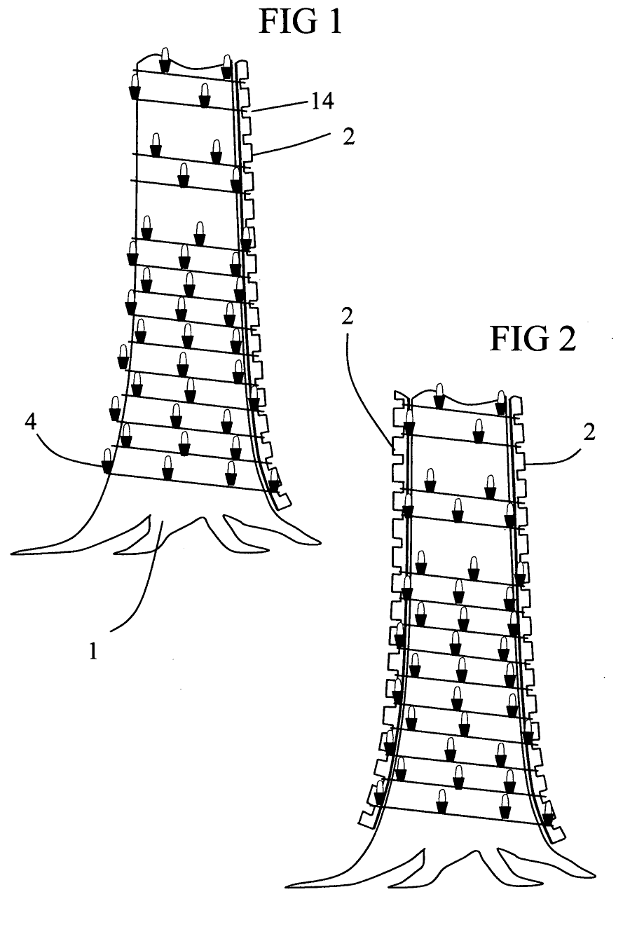

FIG. 1 is a side view of the simplest embodiment consisting of a single alignment comb (2) to ensure constant spacing between parallel rows of decorative lights (4) as they are affixed in a helical fashion to a cylindrical or modified cylindrical object (1). In this embodiment, the decorative lighting alignment comb (2) is installed parallel to the axis of the cylinder. Decorative lights are then wound around the cylindrical object. Row spacing is determined by the selection of alignment comb slots (14). This embodiment is an enhancement to the traditional helical wrapping process.

FIG. 2 is a side view of a simple embodiment consisting of a plurality of alignment combs. Using a plurality of alignment combs ensures more concise alignment between parallel rows of decorative lights and further protects from the ramifications of lights shifting about and disrupting the desired pattern. Two alignment combs (2) are depicted in FIG. 2 The alignment combs are arrayed in a parallel fashion and are parallel to the cylinder's axis. Additional alignment combs can be installed around the circumference of the cylinder to gain additional precision in alignment.

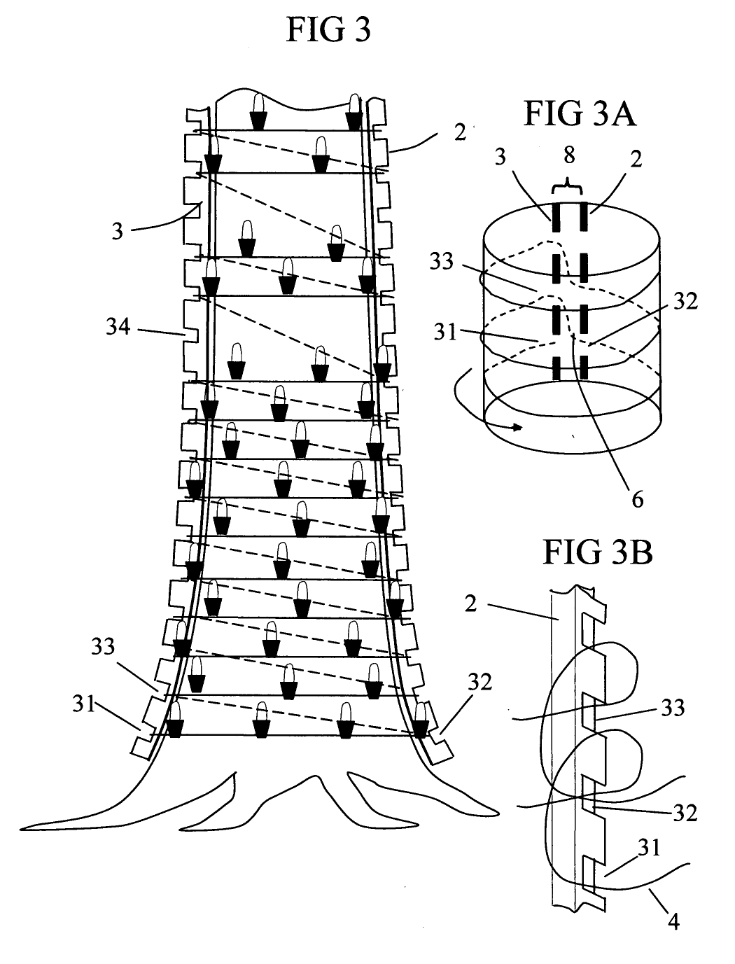

FIG. 3 is a side view illustrating a variation in the embodiment described by FIG. 2. This embodiment requires a minimum of 2 alignment combs (2) and (3) to be attached to the decorated cylinder. Additional combs may be installed around the circumference of the cylinder to gain additional alignment precision. The purpose of the embodiment is to allow a desired portion of the cylindrical object (1) to be wrapped with the decorative lights (4) in a path that is parallel to the cylinder's axis rather than in a helical fashion. The parallel segment is accomplished by passing the decorative string between 2 slots (31) and (32) that are along a line described as perpendicular to the cylinder's axis. The string is first routed from (31) to (32) in a counter clockwise direction. The light string then continues around the cylinder and is inserted in the appropriate slot (33) to impart the desired separation between rows. Slot (34) was bypassed and the light string moved upward to impart additional separation between rows.

FIG. 3A is a 3 dimensional view of a cylindrical section depicting how decorative lighting alignment combs (2) and (3) can be installed about a cylinder to maximize the percentage of the circumference that is perpendicular to the cylinder's axis and minimize the portion of the circumference (8) that is used to gain the rise between adjacent rows. The decorative light string begins at the first slot (31) on comb (2) and is wrapped in a counter-clockwise fashion all the way around the cylinder and passed through the corresponding slot (32) on comb (2). The desired rise is accomplished by routing the decorative string through slot (33) on comb (2).

FIG. 3B depicts a less desirable embodiment that may be used to impart all rise between parallel decorative light string runs using a single alignment comb (2). The light string (4) is passed through slot (31), to slot (33) and then continued through slot (32) to begin the next parallel decorative light wrap. This pattern is then continued until the desired design is imparted to the cylinder.

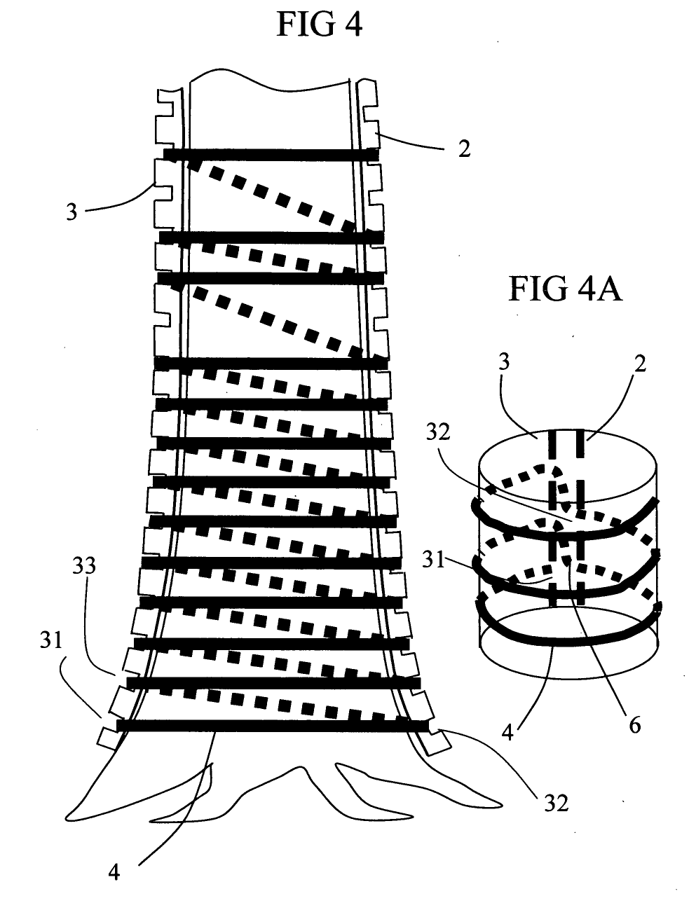

FIG. 4 is a side view illustrating a variation in the embodiment described by FIG. 2. This embodiment is for commercially available decorative rope lighting and requires a minimum of 2 alignment combs (2) and (3) to be attached to the decorated cylinder. Additional combs may be installed around the circumference of the cylinder to gain additional alignment precision. The purpose of the embodiment is to allow a desired portion of the cylindrical object (4) to be wrapped with the decorative lights in a path that is parallel to the cylinder's axis rather than in a helical fashion. The parallel segment is accomplished by passing the decorative string between 2 slots that are along a line described as perpendicular to the cylinder's axis (31) and (32). The string is first routed from (31) to (32) in a counter clockwise direction. The light string then continues around the cylinder and is inserted in the appropriate slot (33) to impart the desired separation between rows. Slot (3) was bypassed and the light string moved upward to impart additional separation between rows.

FIG. 4A is a 3 dimensional view of a cylindrical section decorated with commercially available rope lighting depicting how decorative lighting alignment combs (2) and (3) can be installed about a cylinder to maximize the percentage of the circumference that is perpendicular to the cylinder's axis and minimize the portion of the circumference that is used to gain the rise between adjacent rows. The decorative light string (4) begins at the first slot (31) on comb (3) and is wrapped in a counter-clockwise fashion all the way around the cylinder and passed through the corresponding slot on comb (2). The desired rise is accomplished by routing the decorative string through slot (32) on comb (2). Rope lighting has limitations on its minimum turning radius due to the nature of its' construction. This limitation will determine the minimum distance between alignment combs (2) and (3).

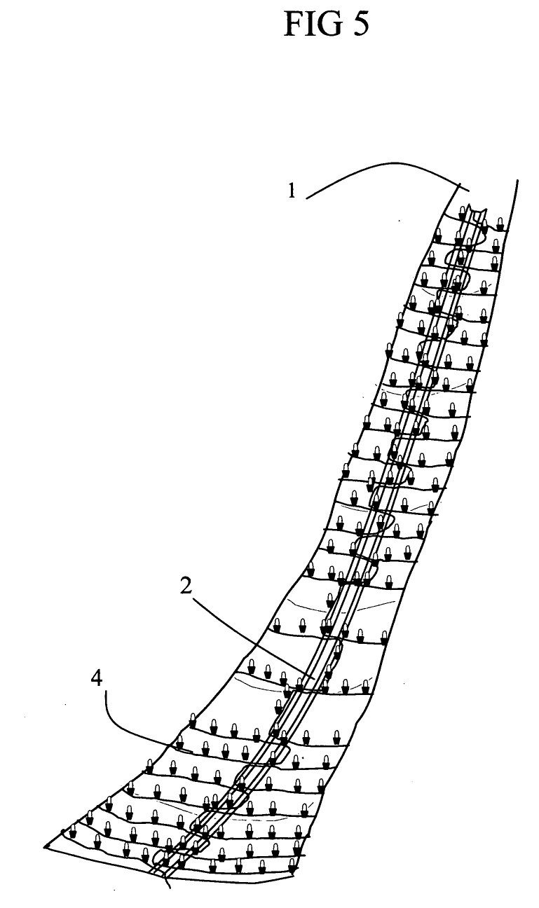

FIG. 5 is an isometric rear view of a curved and tapered tree (1) that has been decorated using the simplest embodiment of the first preferred aspect for this type of shape when decorative lighting attachment spines are used. This embodiment consists of a single decorative lighting spine attachment strip (2). The sample tree trunk shape (1) is an irregular cylinder. The flexible design of the decorative lighting spine attachment strip allows the strip to follow contour deviation from side to side (Y-Axis) and in and out (Z-Axis). This illustrates a multitude of light strings (4) decorating the entire circumference of a tree trunk.

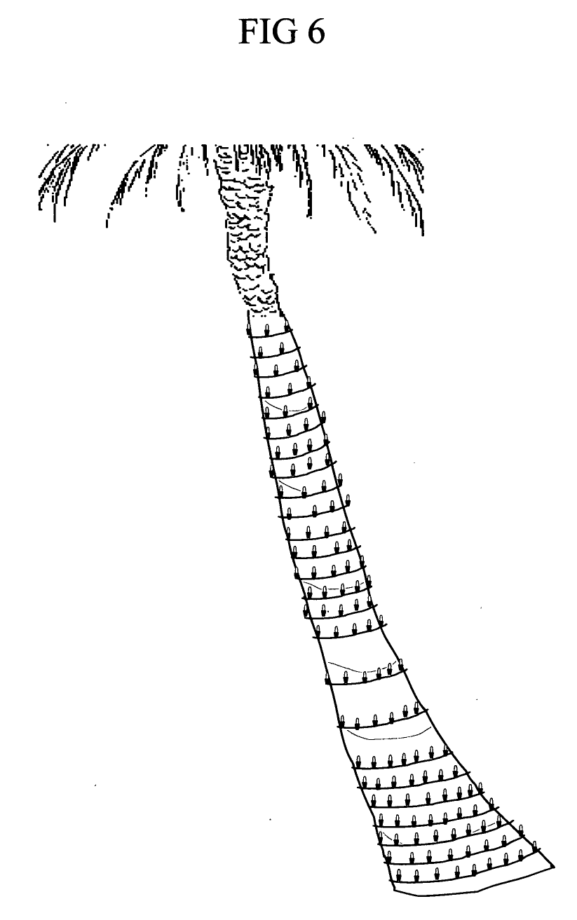

FIG. 6 is an isometric frontal view of the same tree represented in FIG. 5. It is noted that decorative lights have been attached that encircle the tree trunk perpendicular to the axis as opposed to the conventional spiral wrapping that existed prior to this art. This illustration also depicts how the vertical spacing between rows of decorative lights can be varied from 1 slot to multiples thereof.

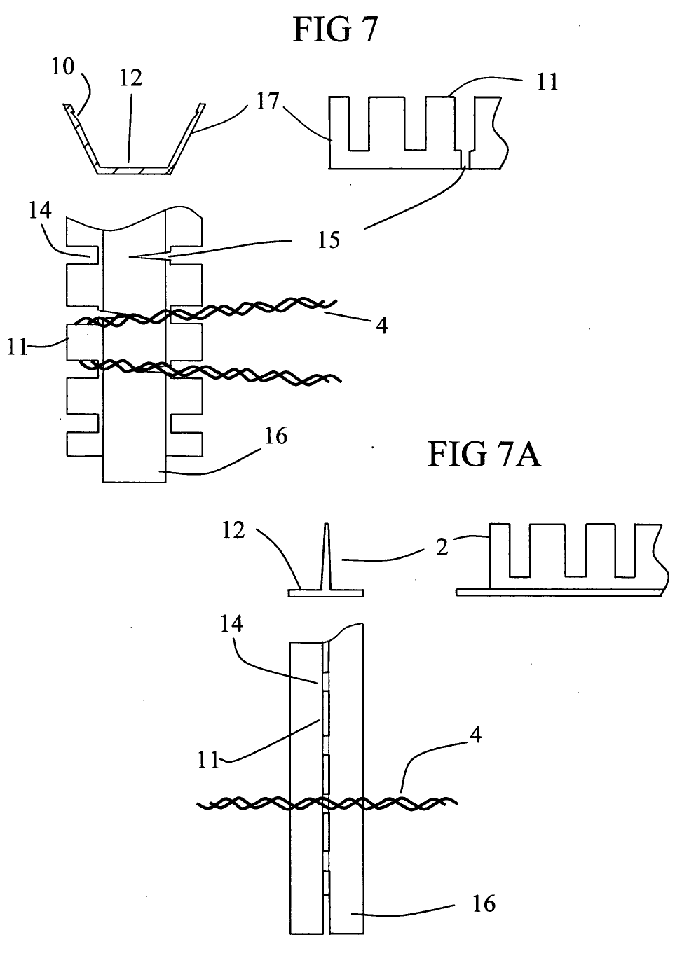

FIG. 7 is a 3-view drawing of a section of the first submitted embodiment of decorative lighting attachment spine (17). The end view depicts the trapezoidal cross section utilized for the spine. There are 3 identifiable elements visible from this view. A notch (10) is provided to allow insertion of an optional decorative lighting attachment spine cover. The optional snap in cover may be used to retain additional inclusions such as power or sequencing cords. The optional cover is also utilized to darken or hide light bulbs that may be positioned in a manner that is disruptive of the desired pattern. Angled prongs (11) are used as wrapping posts and attachment points for strings of decorative lights. The angled prongs also serve as sidewalls when decorative lighting strings or power cords which may go directly to an AC power source or any of the commercially available lighting sequencer controls are routed down the length of the decorative lighting attachment spine. The spine utilizes angled prongs rather than prongs perpendicular to the spine base (12) for a multitude of reasons.
1. Commercially available strings of decorative lights typically utilize 2 or more twisted wires. In addition, they typically exhibit kinks and bends due to the way the decorative light strings are commercially packaged. Once the lights have been mounted and received any amount of tension due to gravity and/or stretching around the prongs, the twists will tighten and the kinks can straighten. Overall, this will cause the decorative strings to lengthen and allow them to slip off of perpendicular prongs (11) if used as wrap points.
2. The recommended method of wrapping decorative lighting strings (4) about a prong (11) will apply an equal amount of compression and shear forces upon the structure of the prong. Using perpendicular prongs translates all forces imparted by the decorative lighting strings into a pure shear force thus necessitating thicker construction and reduced overall flexibility of the spine.

Sidewall Slots (14) are used for the embedment points to contain the decorative light strings being wrapped around the prongs. They are also flex points to allow the spine to flex in and out (Z-Axis) to follow contours of irregular cylindrical shapes and the slots allow the use of nylon or plastic straps for mounting purposes. Bottom slots (15) allow flexing from side to side (Y-Axis) to follow the contour of irregular shapes. Bottom slots are optional and will be included when plastics lacking adequate flexibility are used for spine construction. Decorative lighting attachment spines can be manufactured in various lengths. Practical lengths can be bounded by such factors as what is easily packaged and shipped via common carriers and/or what length item is readily stocked and displayed in the retail environment. For required lengths that are shorter that the manufactured section the user can easily cut the furnished spines to the desired length with common household tools. When additional length is required, a multitude of decorative lighting attachment spines can be installed end to end. Each decorative lighting attachment spine has an alignment tongue (16), which facilitates alignment of adjoining spine sections. There exists a multitude of sizes and numbers of slots, prongs, widths and prong angles since the attachment spines support a plurality of uses, lighting types and environments. Attachment spines and decorative covers can be molded in a multitude of colors and textures. Various plastics exhibiting the desired Ultraviolet resistance, flexibility and strength can be utilized. In some instances users may desire to paint the spines to match the object to which they are attached in order to reduce their daytime visibility.

FIG. 7A is a 3-way drawing of a section of the first submitted style of decorative lighting alignment comb. The alignment comb (2) is a simplified apparatus and is used to help maintain the desired spacing between parallel rows of decorative lights. Light strings are not wrapped about the prongs (11) of the alignment comb which results in no side loading or stress for this apparatus. The end view depicts the T shaped cross section utilized for the comb. There are 3 identifiable elements visible from this view. Prongs (11) are used as alignment points for strings of decorative lights (4).

Decorative lighting alignment combs can be manufactured in various lengths. Practical lengths can be bounded by such factors as what is easily packaged and shipped via common carriers and/or what length item is readily stocked and displayed in the retail environment. For required lengths that are shorter that the manufactured section the user can easily cut the furnished combs to the desired length with common household tools. When additional length is required, a multitude of decorative lighting alignment combs can be installed end to end. Each decorative lighting alignment comb has a pair of alignment prongs (16), which facilitate alignment of adjoining comb sections. The alignment prongs straddle the first prong of the next alignment comb.

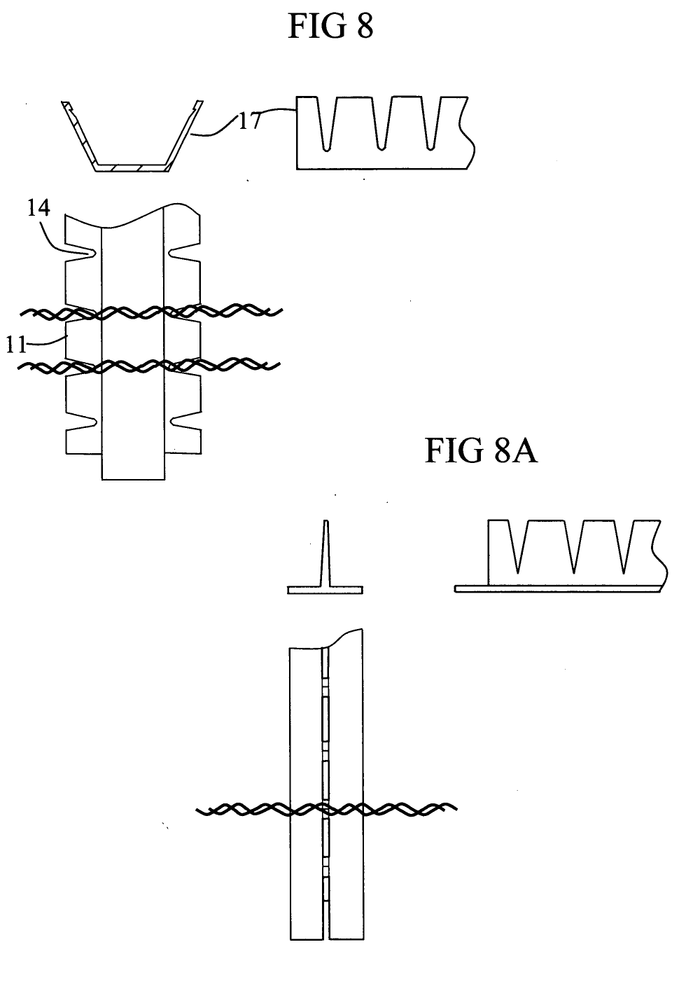

FIG. 8 shows the second submitted style for the decorative lighting attachment spine (17). The primary difference being a tapered or V shaped slot (14). This variation of the embodiment illustrated in FIG. 7. provides greater precision in lighting string alignment than the straight or non-tapered slot utilized in that variation.

FIG. 8A shows the same design variation as FIG. 8 applied to the decorative lighting alignment comb.

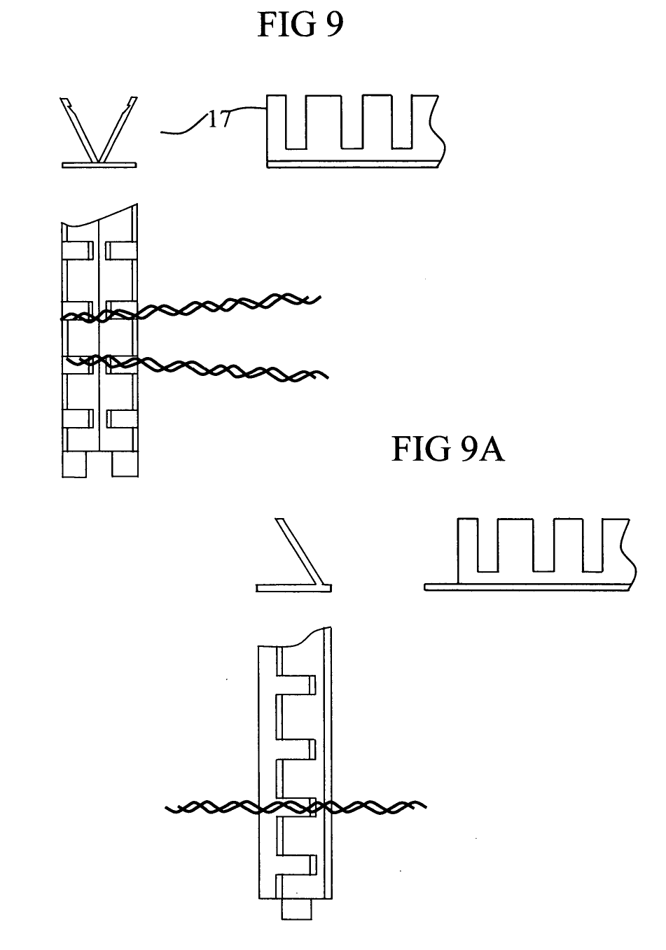

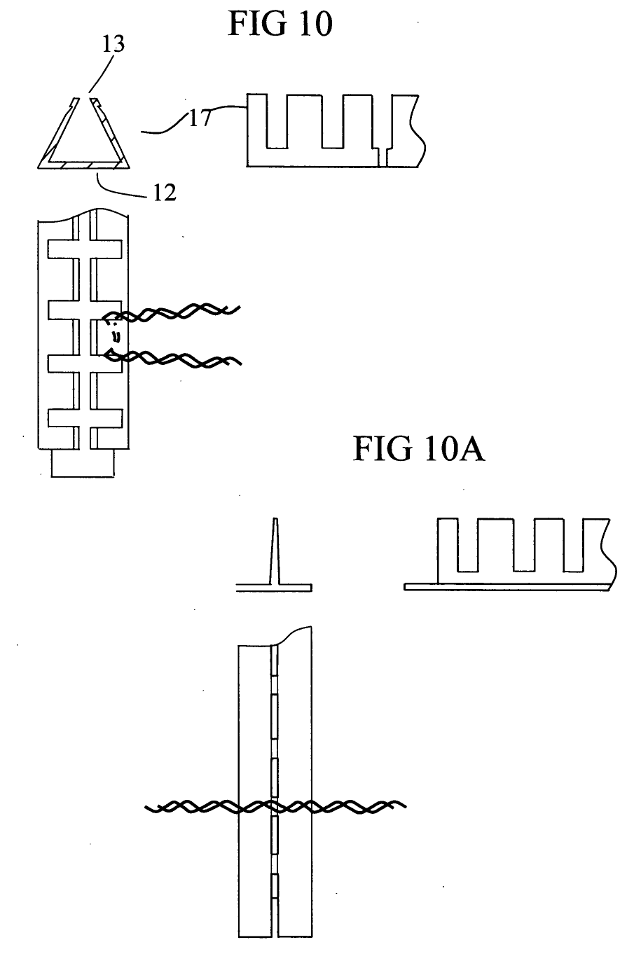

FIG. 9 shows the third submitted style for the decorative lighting attachment spine (17). This variation of the original embodiment illustrated in FIG. 7 offers a smaller footprint and is thus less visible under daytime lighting conditions.

FIG. 9A shows the third submitted style of the complimentary decorative lighting comb. This version of the embodiment can also be used as a decorative lighting attachment spine when decorative lights are to be attached and ran in a fashion such that all light runs enter and exit from the same direction.

FIG. 10 shows the fourth submitted style of decorative lighting attachment spine (17). This style performs the same functions as the previous styles. However in this embodiment, the trapezoidal cross section is inverted from the previous styles and the base (12) is wider than the aperture between the rows of prongs (11). This style permits decorative lighting strings to be wrapped from both sides without overlapping each other. This style permits the wrapping of different colors with no overlapping and therefore creates a “crisper” edging between colors.

FIG. 10A shows the fourth submitted style of the complimentary decorative lighting comb. This version of the embodiment can also be used as a decorative lighting attachment spine when decorative lights are to be attached and ran in a fashion such that all light runs enter and exit from the same direction.

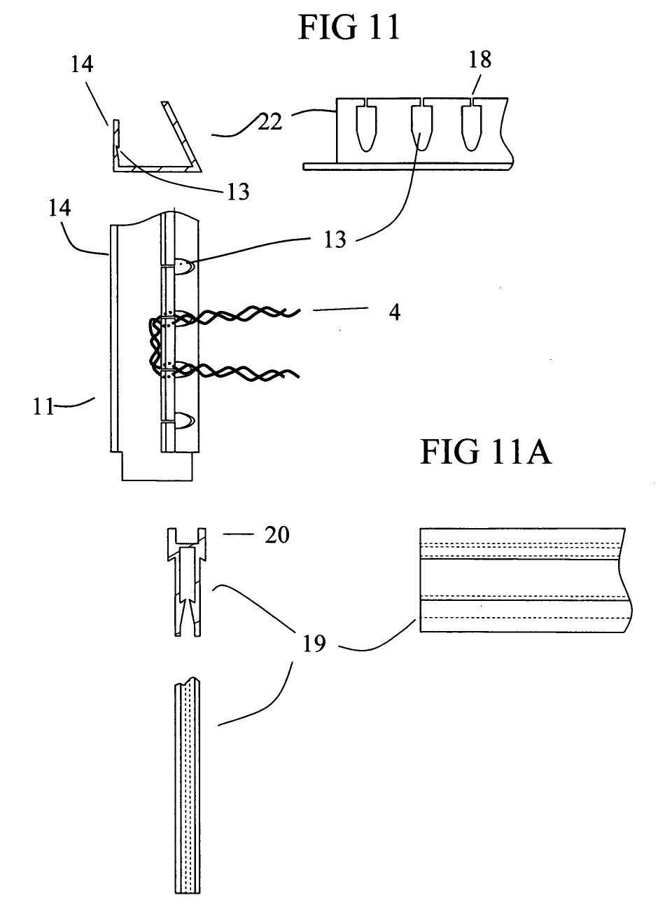

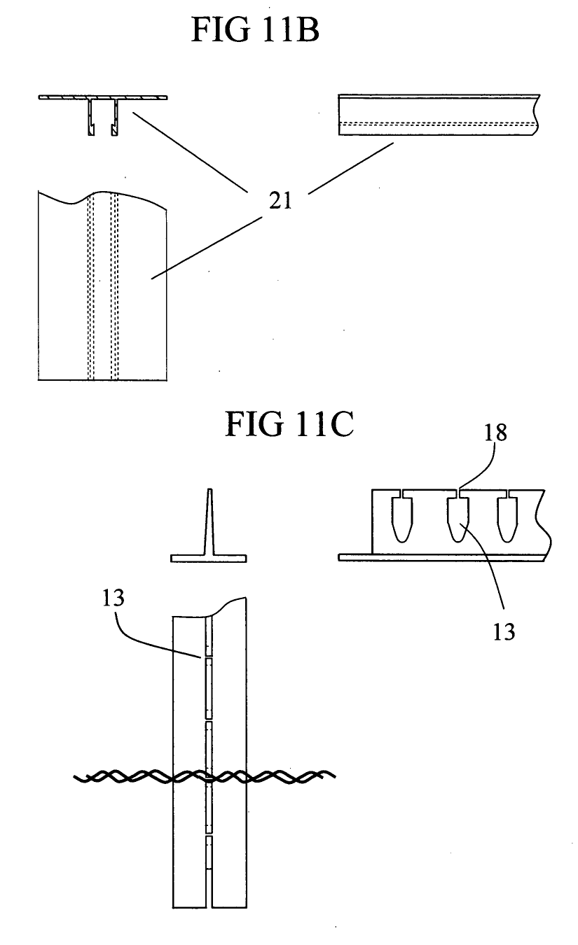

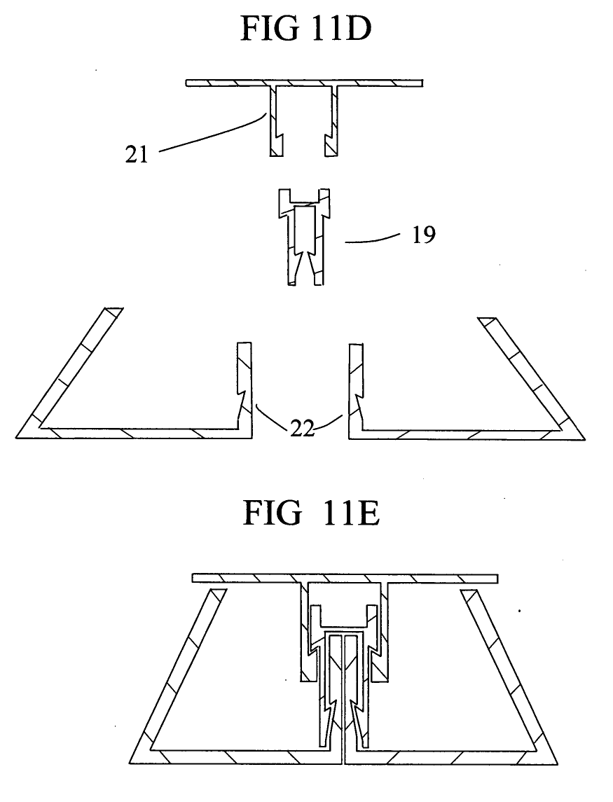

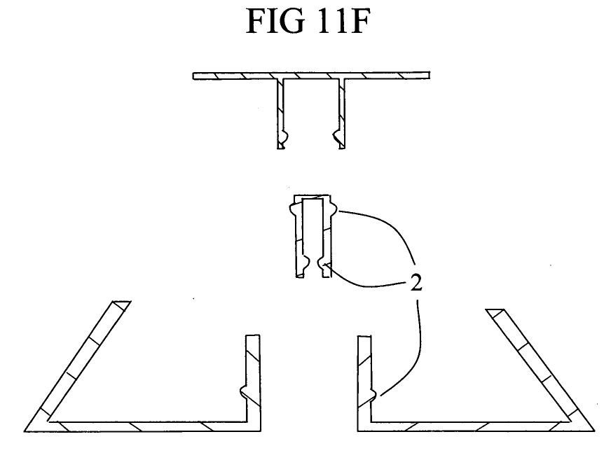

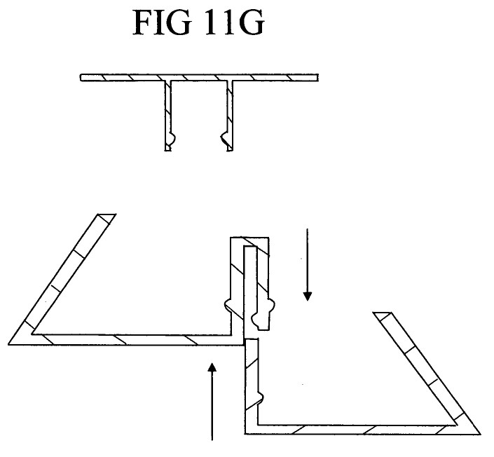

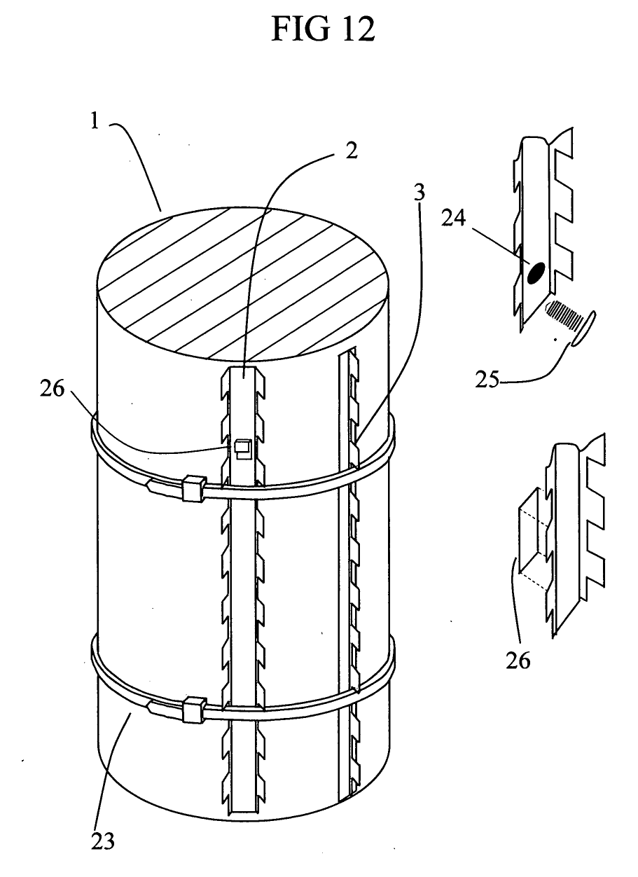

FIG. 11 shows one of the parts used to assemble the fifth submitted style hereinafter referred to as the divisible style of decorative lighting attachment spine (22). This style is radically different from the previous styles in that the spine consists of 3 parts, which can be disassembled and reassembled. An assembled spine utilizes 2 of the decorative lighting assembly spine halves (22) depicted in this figure.

This divisible style of decorative lighting assembly spine is unique in that it allows the 2 spine halves to be attached to each other to form a 2 sided spine and it allows them to be detached from each other while still keeping the attached strings of decorative lighting attached to the spine halves.

The lighting slots (14) are covered by flaps (18) that must be flexed to allow lighting string wires to be inserted into the slot (14). Thus, the flaps (18) trap the wires (4) within the slots. This allows the 2 spine halves (17) to be detached from each other and the 2 spine halves and the inserted decorative lighting strings are removed as a reusable assembly consisting of 2 spine halves and lights that are ready to reinstall and replicate the original design.

Item (13) is a notch that will be used to interlock the prongs of the decorative lighting attachment spine halves with the decorative lighting attachment spine mating clip which is described in FIG. 11A.

FIG. 11A is the decorative lighting assembly attachment spine mating clip (19) that is used to attach the 2 decorative lighting attachment spine halves to each other. When it is desired to disassemble the spine the user can squeeze the 2 mating clip (19) extensions (20) toward each other and spread the bottom of the mating clip apart. The decorative lighting assembly spine-mating clip can be manufactured in any length. It can equal the length of the decorative lighting attachment spine itself or it can be manufactured in smaller lengths. Using a multitude of shorter clip lengths would allow greater flexibility when irregular and/or tapered cylindrical objects are being decorated.

FIG. 11B is the decorative lighting attachment spine assembly cover (21) that is compatible with the divisible style of assembly. It attaches to the decorative lighting spine assembly mating clip or clips.

FIG. 11C illustrates a decorative lighting attachment comb (2) that is compatible with the submitted divisible style of decorative lighting attachment spine assembly. This style of alignment comb has V shaped slots (13) that are terminated on the outside by flaps (18) that retain inserted wires in the same fashion as the 2 decorative lighting attachment spine halves. This ensures that the decorative lighting assembly comb or combs will remain attached to the removed decorative lighting assembly consisting of spine halves, decorative lights and combs.

FIG. 11D is an exploded view showing the relationship between the four basic elements of a divisible decorative lighting attachment spine. Two spine halves (22) are placed side-by-side and abutted to each other. There is only one part number used for both halves since they are symmetrical and all one has to do is turn them the right way to effect the proper relationship. One or a multitude of divisible decorative lighting attachment spine mating clips are then pushed down over the 2 abutted spine halves. The divisible decorative lighting attachment spine halves (22) are physically locked together by using attachment spine mating clips (19). The optional spine cover (21) may be used if desired to hide lights within the channel formed by the attachment spine halves.

FIG. 11E shows a view of all 4 parts described in FIG. 11D then they are assembled.

FIG. 11F shows one of many variations of the components used in the divisible decorative lighting attachment spine assembly. In this instance the notches shown in FIGS. 11E and 11D are replaced by molded ridges (2). This type of retention would be easier to incorporate when thin sidewalls are used. There are other retention methods that can apply but hopefully 2 illustrations convey the basic design intention.

FIG. 11G illustrates another version of a divisional decorative lighting attachment spine.

The inherent advantage in the overall submitted invention is in the flexibility and multitude of uses for the many components of the decorative lighting attachment system.

The following drawings illustrate many embodiments of selected components. It should be pointed out that a given illustration might depict the original or first style of decorative lighting attachment spines and combs.

Each of the depicted styles offers inherent advantages. Style 1 in FIG. 7 is usable on any shape or surface. Style 2 in FIG. 8 is usable on any shape or surface and provides better precision in decorative lighting placement and alignment. Style 3 in FIG. 9 is intended to offer a lower footprint and thus be less obvious during daylight hours. Style 4 in FIG. 10 allows differing colors or designs to be wrapped from each side with no overlap of light strings. This provides a crisper demarcation between differing implementations. Style 5 (divisible style) in FIG. 11 is intended for applications where it is desirable to implement and apply a design that removed and reapplied with a minimum of labor. This would be especially useful for the emerging business of professional decorators who apply Christmas decorations, remove them, warehouse them and re-apply them the next season.

None of the embodiments in the following drawings are limited to any of the submitted styles or logical variations and modifications thereof.

FIG. 12 is an isometric section of a cylindrical object (1) illustrating placement of a single decorative lighting attachment spine (2), a decorative lighting alignment comb (3) and their attachment methods. The preferred method of attachment to live tree trunks and branches is to utilize plastic ties (23) As an alternative method, wood or metal screws (25) can be inserted directly through holes (24) drilled in the decorative lighting attachment spine. Another alternative is to use medium or heavy-duty 2-sided tape (26) to attach to smooth surfaces. The mounting clip (26) is molded into all spine and comb types. This clip is used when 2 or more of any combinations of spines or combs are to be attached to a cylindrical object. A plastic tie or any other sort of cord or cable can be affixed under the clip which allows an installer to bring the entire assembly up to its' topmost point and wrap it around the intended object. The spines and combs can be loosely position and moved about as desired prior to final emplacement by any of the methods shown in FIG. 12.

The same attachment mechanisms utilized for decorative lighting attachment spines are also utilized to attach decorative lighting alignment combs to cylindrical shape. In many instances, alignment combs and attachment spines will be pressed against the decorated object by the tension imparted from decorative lights that pass through their slots. In this instance, the preliminary attachment method is only required to establish the initial position of combs and spines prior to mounting the decorative lights.

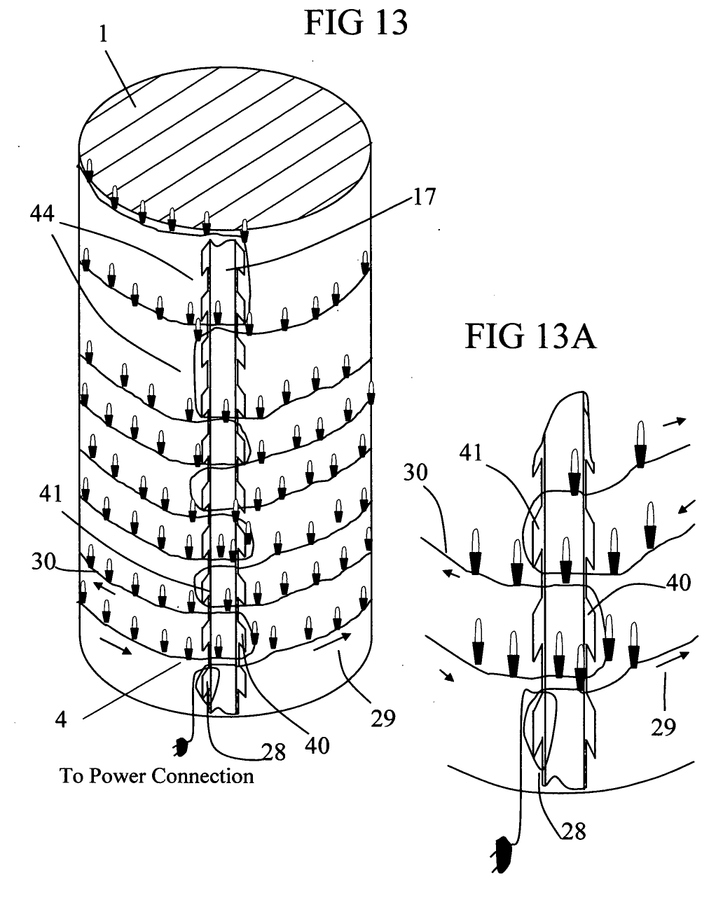

FIG. 13 Illustrates one method used to implement a simple embodiment of the decorative lighting attachment spine for wrapping decorative lights around a cylindrical object (1) and intertwining the decorative lights within the decorative lighting attachment spine (17) to accomplish a pattern of lighting. There exists a multitude of wrapping methods that may be employed. This example was selected, as it is a preferable method to implement parallel designs that are perpendicular to the cylindrical object's axis. Initial attachment of the first decorative lighting string, (4) can either be effected by wrapping the string around a prong selected as the anchor prong (32) or clipping the string to that prong. The string of lights is then wrapped in a counter-clockwise fashion (29) around the circumference of the cylinder. Wrapping the string around the next highest prong (40) on the other side of the decorative lighting attachment spine (17) then terminates the counter-clockwise passage. The string of decorative lights is now wrapped in a clockwise direction (30) around the cylindrical object parallel to the first counter-clockwise wrap. This wrap is then terminated by, wrapping the decorative light string around the next highest prong on the leftmost side of the decorative lighting attachment spine (41).

The spacing interval between adjacent parallel wraps of decorative lighting strings can be widened by extending the termination point of a wrap to include a multitude of prongs within the wrap (44).

FIG. 13A is detailed section of the cylinder depicted in FIG. 13. Also contained in FIG. 13A is a depiction of one of the multitudes of clip types that may be used to perform initial attachment of a light string (4) to the attachment spine (17).

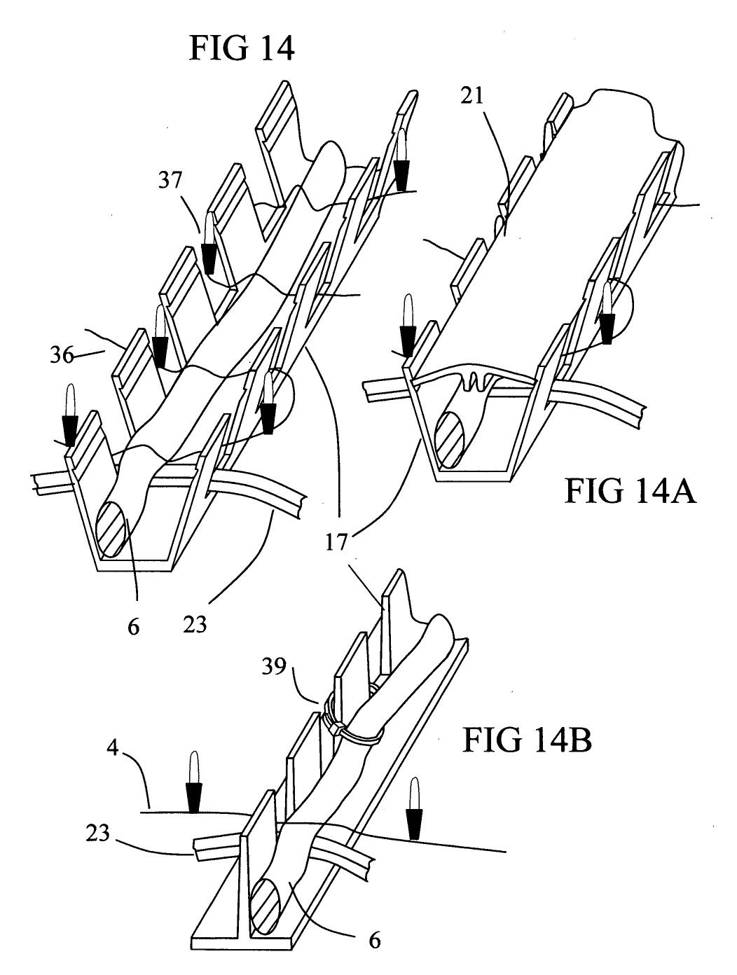

FIG. 14 is a short section of a decorative lighting attachment spine (17). Included in this drawing is detail showing how decorative lighting strings (4) are wrapped around the prongs. Detail 1 (36) represents a portion of a string of decorative lights (4) entering the attachment spine from the left, wrapping around an attachment prong on the right side of the spine and exiting the spine via the left side. Detail 2 (37) represents a string section entering from the right, wrapping around a prong on the left side of the attachment spine and exiting via the right side. Detail (22) illustrates how an attachment plastic tie (23) can share the same slot as a decorative string of lights. Power cords (6) can be routed within the decorative lighting attachment spine.

FIG. 14A depicts how the optional attachment spine cover (21) may be affixed to retain inclusions such as power cords routed within the spine structure. This cover may apply to any embodiment using the decorative lighting attachment spine or alignment comb. The flexible cover (21) snaps into ridges that are molded into the inside of the attachment spine prongs.

FIG. 14B depicts a short section of a decorative lighting alignment comb. Included in the view is detail showing how an attachment plastic tie (22) can share the same slot as a string of decorative lights (4). Also included is detail illustrating how an alignment comb can be used as a power cable (6) routing method. One method of power cord (44) retention is to utilize commercially available plastic ties (40) as required.

FIG. 15 Illustrates a complex embodiment for a cylindrical or a modified cylindrical object (1) comprised of two attachment spines (17) and (17A) affixed parallel to the axis of the object. Two parallel spines allow the user to only wrap or decorate a desired portion of the circumference of the object and thereby utilize a lesser number of lights, reduce energy consumption by only covering the portion of the object that is visible to the target audience and reduce the distance the lighting installer must access. The starting point of the first decorative lighting string (4) is attached by either wrapping the connector end around an anchor or starting prong (28) or clipping it to the prong. The string of lights is then wrapped (37) in a clockwise fashion around the circumference of the cylinder to the point where it can then be wrapped around the desired prong (36) on rightmost attachment spine (17A). The lighting string is then wrapped around the circumference of the cylinder in a counter clockwise direction until it can be wrapped around the next highest prong (38) on attachment spine (17). At this point, the decorative lights can then be wrapped back and forth between the two spines until the desired area to be decorated is covered. The distance between parallel rows of lights may be increased by skipping additional prongs on attachment spines (17) and (17A).

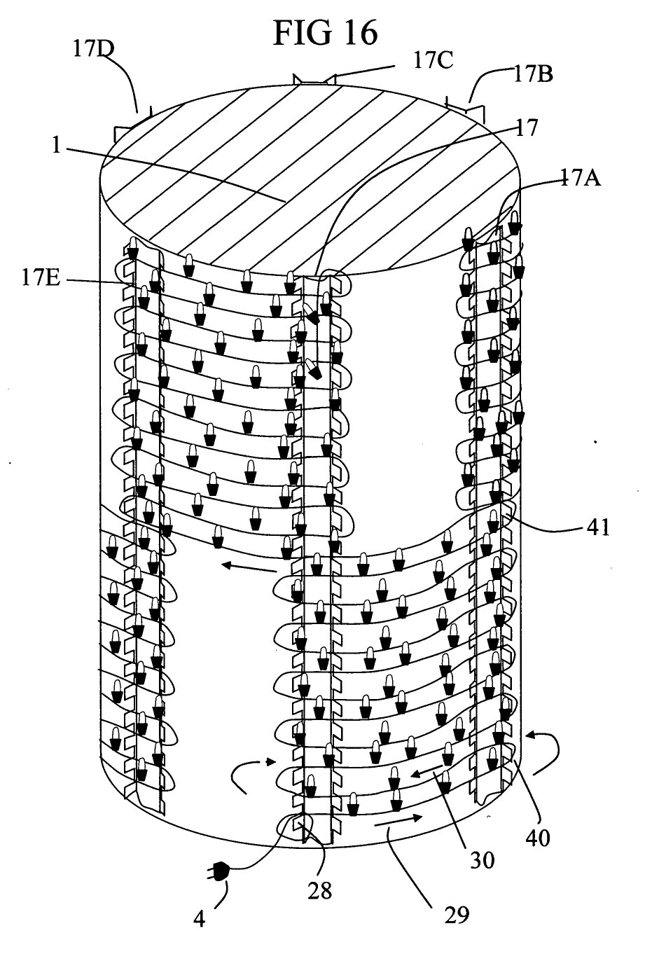

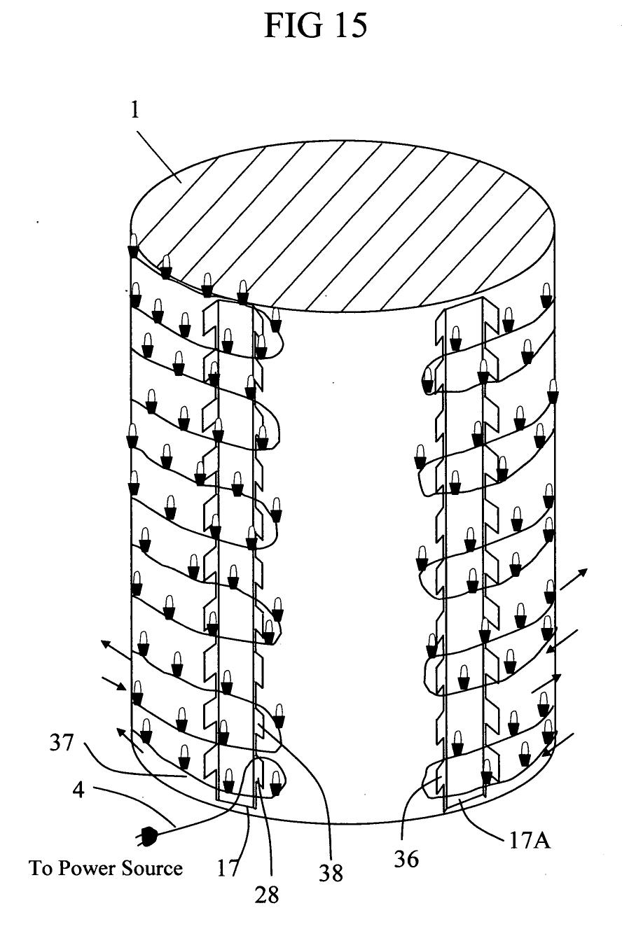

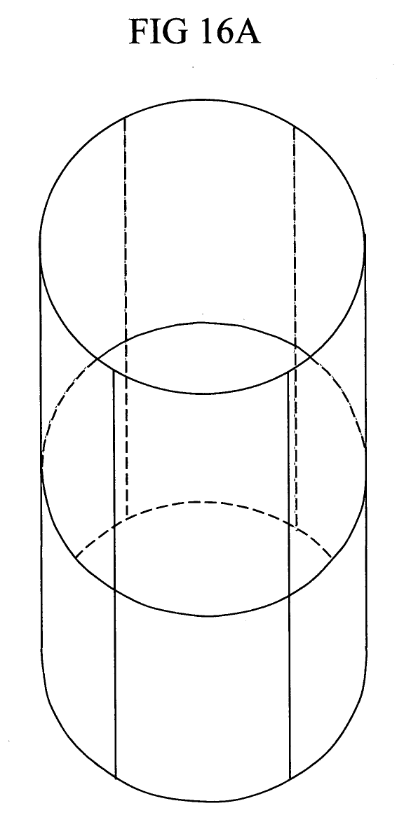

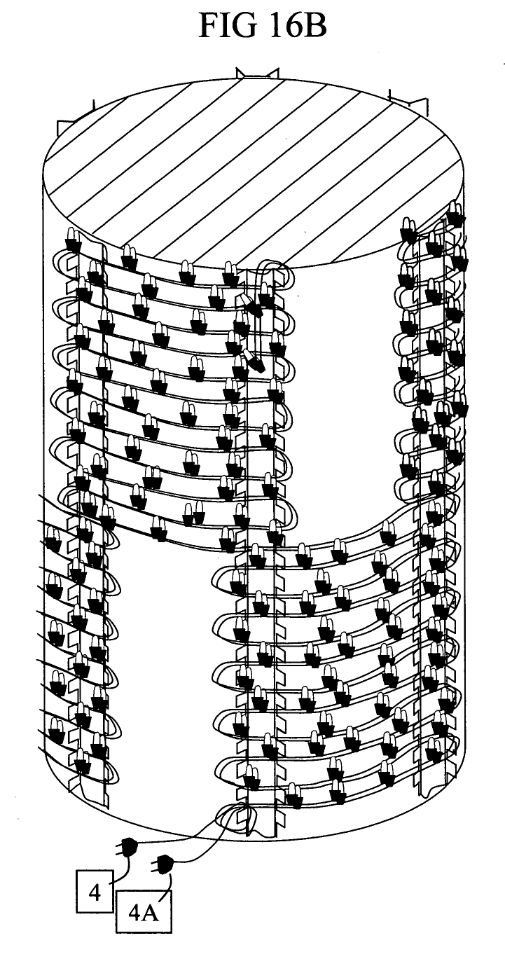

FIG. 16 illustrates an additional complex embodiment of this invention. Three or any plurality of decorative lighting attachment spines or alignment combs can be used to impart geometric designs on cylindrical objects (1). Patterns can consist of lighted areas in conjunction with un-lighted areas, different colors of lights, different types of lights or a combination of a multitude of colors and un-lighted spaces. The example used contains 6 decorative lighting attachment spines (17, 17A, 17B, 17C, 17D and 17E) arranged 60 degrees apart around the circumference of a cylinder and placed parallel to its' axis. In this example the spines span the cylinder from top to bottom. In the actual practice of the art, a user can use an unlimited combination of spines and can vary their top to bottom length and placement as desired.

The following instructions describe how to implement the illustrated pattern. A string of decorative lights (4) is attached to the desired attachment spine anchor prong (28) on attachment spine (17). The light string is then routed in a counter clockwise direction (29) and wrapped around the prong that is one prong higher (40) than the anchor prong (28) on attachment spine (17A). The light string (4) is then routed in a clockwise direction (30). The light string is then routed back and forth until the prong (36) located at the planned height for this pattern element is attained. Once the planned height is attained the light string is routed past the starting alignment spine (17), which contains the starting anchor prong (28) and continued to the prong on the next alignment strip (17E) that affords routing the lights in a straight line from prong (41) on spine (17A).

The lighting string is then routed back and forth between alignment strips (17) and (17E) until the desired height is attained. In this instance the desired height is the top of the cylindrical object. Excess lights that remain unused when the pattern is completed my be either placed within the attachment spine or routed over the existing mounted lights until such time as any excess is consumed. If decorative lights placed within a spine disrupt the desired pattern, the optional cover may be emplaced to conceal the lights.

This same process would then be repeated between spines (17E) and (17D) as well as between (17C) and (17B) in order to emplace the pattern around the entire circumference of the cylinder.

FIG. 16A is a 3-dimentional view illustrating how the overall pattern looks on the cylinder decorated in FIG. 16. The shaded areas represent the portions that contain decorative lights. The un-shaded areas represent portions that are unlit. There exists an unlimited multitude of design patterns that can utilize any plurality of attachment spines and combs. In addition, one who practices the art will discover many wiring methods and placements that will allow them to personalize an object of their choice.

FIG. 16B depicts another overall variation applies to all types of objects and surfaces that may be decorated using any embodiment of this invention. This variation centers upon the capabilities of decorative lighting attachment spines and alignment combs to allow installation of a plurality of layers of decorative lights. The cylindrical object is decorated with an initial layer of decorative lights (4) in the same fashion as described for FIG. 16. A second layer of decorative lights (4A) has been applied to the cylindrical object. Additional layers of decorative lighting may utilize the same style and color of decorative lighting utilized in the first layer or any other available style and color of lighting. Additional layers of decorative lighting may be applied in the same pattern used for the initial layer or any other desired pattern variation. Additional layers of decorative lighting may be connected to the same power source as the initial lighting layer and be turned on and off at the same time as the initial layer. Additional layers of decorative lights may be powered separately from the initial layer, which allows different layers, or a combination of layers to be lighted as another layer or layers are unlighted.

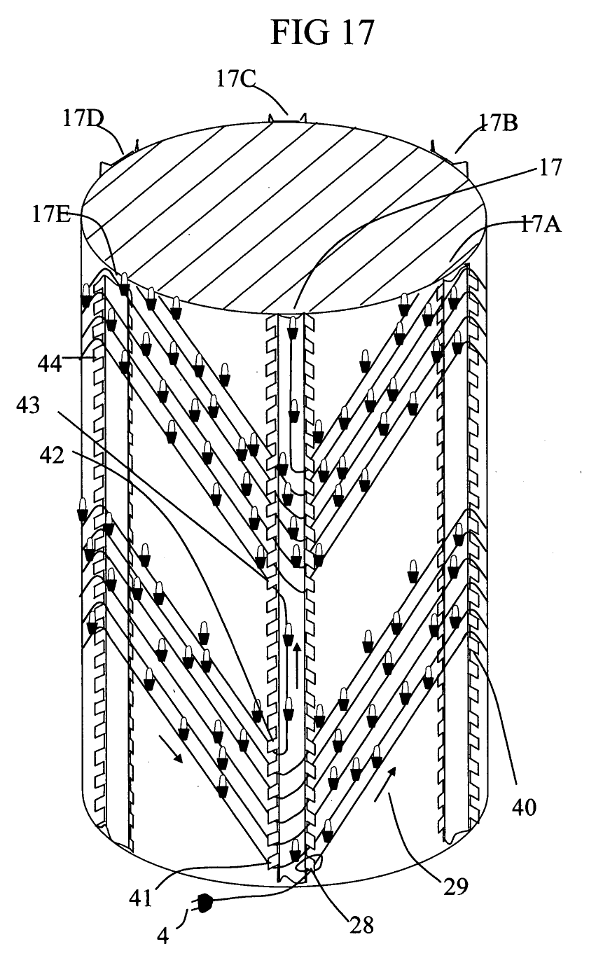

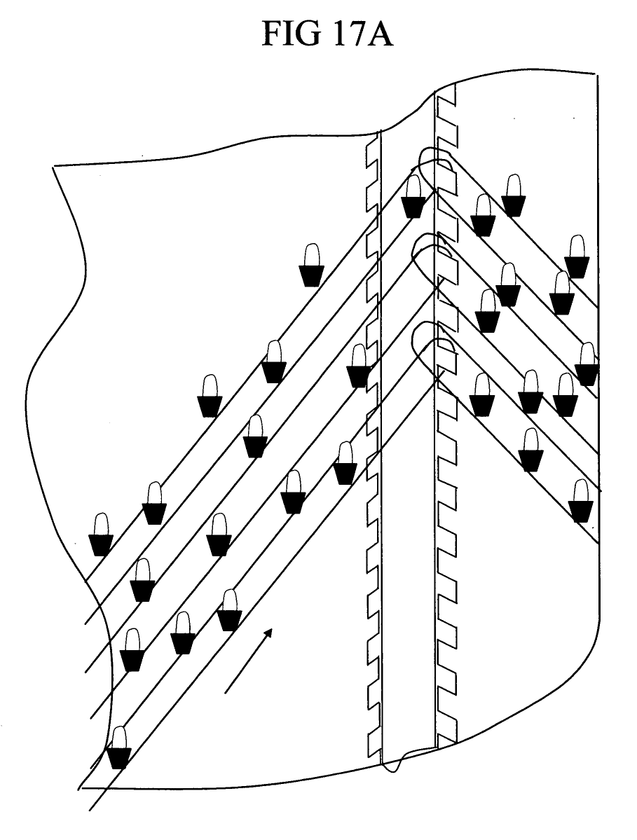

FIG. 17 illustrates another possible type of design that can be implemented by the same complex embodiment shown in FIG. 16. This example also contains 6 decorative lighting attachment spines (17), (17A), (17B, (17C, (17D and (17E) arranged 60 degrees apart around the circumference of a cylinder and placed parallel to its' axis.

A string of decorative lights (4) is attached to the desired anchor prong (28) on attachment spine (17). The string is then routed in a counter clockwise direction (29) and looped over the prong (40) selected on attachment strip (17A) that will impart the desired pattern angle.

The counter clockwise application of the light string then continues with the string being alternately looped about the prong that is of the same height as prong (28) and the prong that is the same height as prong (40) on attachment spines (17B), (17C), (17D), and (17E). When the string completes the first full circle about the cylinder by reaching attachment spine (17) it is then looped under prong (41) on attachment spine. The same path around the cylinder alternating from high to low and stepping up one prong per revolution is continued until the desired height is attained for this pattern element. When the desired height is attained, the light string is looped around the last prong (42) used in this pattern element and routed up the interior of attachment spine (17) until the desired spacing between 2 lighted pattern elements has been attained. When the desired vertical spacing is attained the light string is looped over the bottom most prong (43) to be used in the second lighted pattern element and on to prong (44) on attachment spine (17E) that establishes the same angle for the second pattern element as the first element. This process is repeated until the desired overall pattern has been implemented on the cylinder. Spacing between parallel rows of lights and design elements can be varied as desired. If decorative lights that are embedded inside attachment spine (17) are disruptive to the overall pattern, they can be covered and obscured with an attachment spine cover to hide the lights that would be visible within the dark or un-lighted band of the design.

FIG. 17A better illustrates one of a multitude of alternate methods of assembling the same complex embodiment illustrated in FIG. 17.

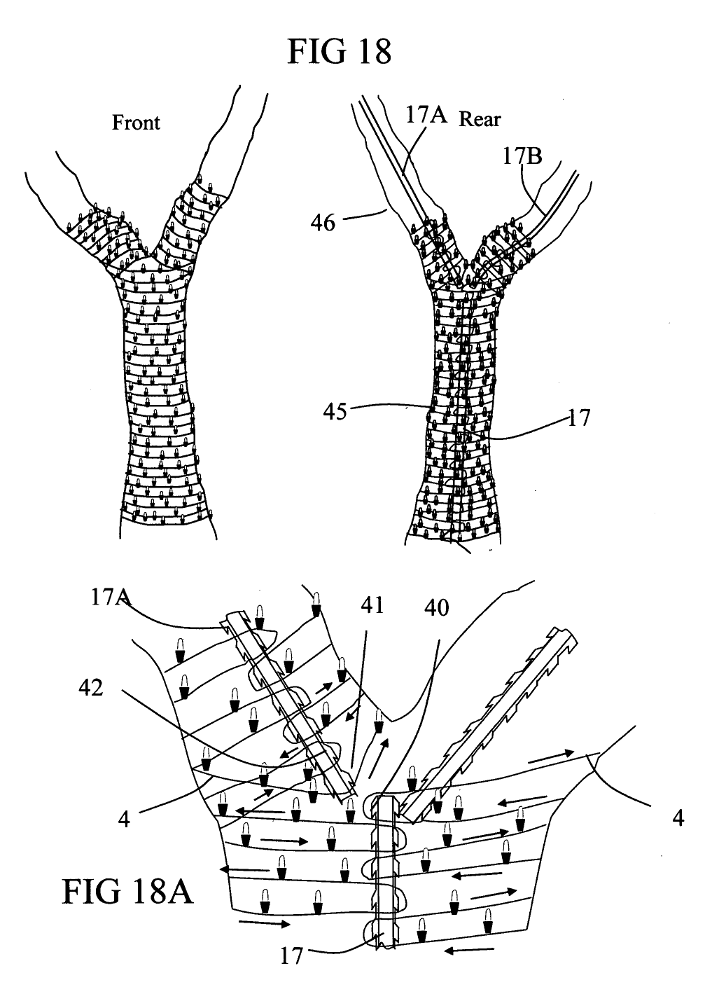

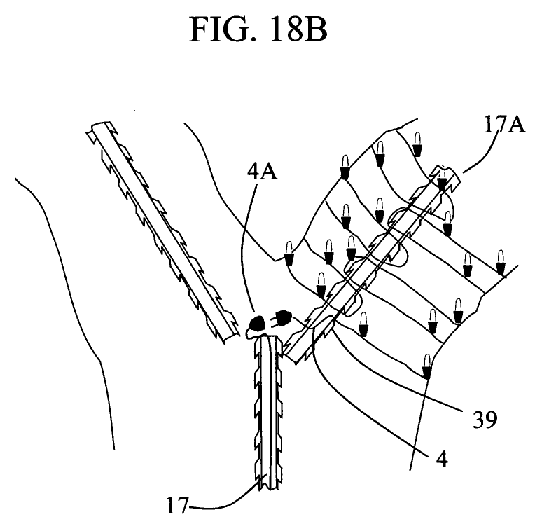

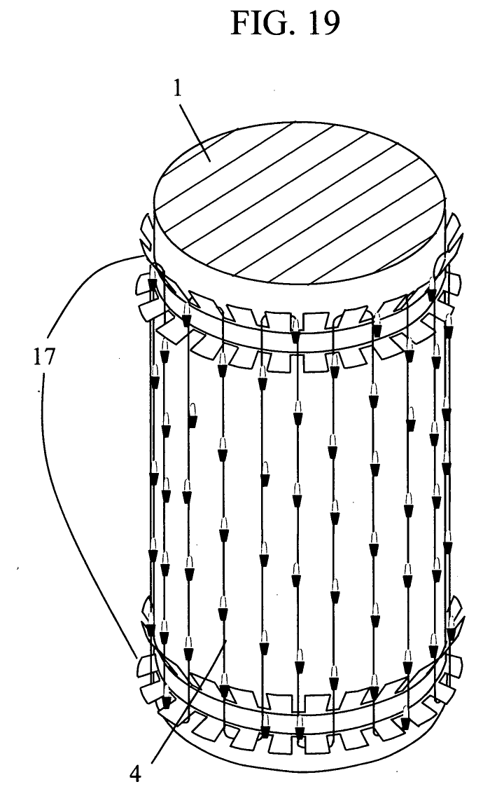

FIG. 18 contains a front and rear view of a complex embodiment of this invention. It illustrates a bifurcated tree section that has been decorated using decorative lighting attachment spines. The basic techniques for attaching decorative lights to a branched object are the same as a cylindrical object (see FIG. 6). The front and rear views serve to show the placement of decorative lighting attachment spines (17), (17A and (17B). Attachment spine (17) is oriented along the vertical axis of the tree trunk. Spines (17A) and (17B) are oriented along the axe of the 2 bifurcations. The simplest method to decorate the juncture in a bifurcated object is to continue the light string (4) used to decorate the trunk (45) onto one of the branches and begin a new string to decorate each of a plurality of branches at the juncture where the branches meet the trunk (46).

FIG. 18A is a detail of the rear view of the decorated tree shown in FIG. 18. Decorative lights are wrapped back and forth around the trunk with each wrap terminating at a prong on attachment spine (17) in the normal fashion used for cylindrical objects. The final counter-clockwise wrap around the trunk (4) is made from the top prong (40) of attachment spine (17). As the wrap nears spine (1) it is hooked around the bottom prong (41) of spine (2). The light string is then wrapped through the notch between the bifurcations, wrapped around the left branch (5) and hooked around prong (42) of spine (2). The string of decorative lights is now wrapped back and forth along the axis of the left branch (5) with the wraps terminated on the prongs of attachment spine (2) until the end of the desired pattern is constructed.

FIG. 18B shows one of a multitude of methodologies that can be used to decorate the branches of a forked object that are not wrapped as a continuation of the main trunk. The first string of decorative lights (4) is wrapped around an undecorated branch and alternately anchored to left and right prongs of attachment spine (17A). Power for this string or strings of decorative lights can be provided by either plugging this string into the power path utilized for the light strings used to decorate the trunk and the first branch or by running an independent power cord (4A) along the attachment spine path (17) used to decorate the main trunk.

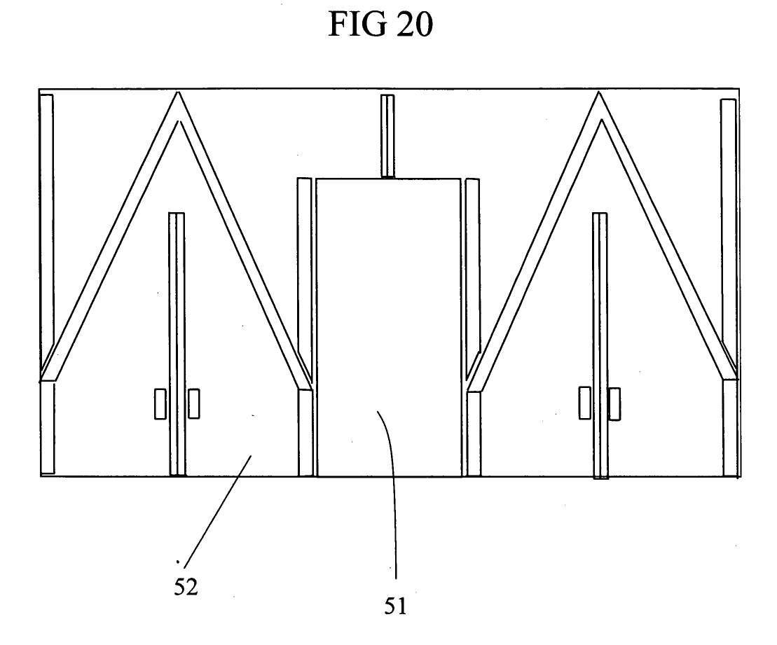

FIG. 19 depicts another embodiment of using 2 decorative lighting spines (17) on a horizontal plane to decorate a cylindrical object (1) with vertically oriented strings of lights (4). Spines and combs can be installed at any angle on any targeted object and surface.

FIG. 20 represents a wall, which includes a door (51) that has a multitude of decorative lighting attachment spine sections and decorative lighting alignment combs attached. The installer has options as to how the spines and combs are attached and may elect to leave the spines and combs in the color they were manufactured or, repaint them to match the wall they re attached to in order to reduce their daytime visibility.

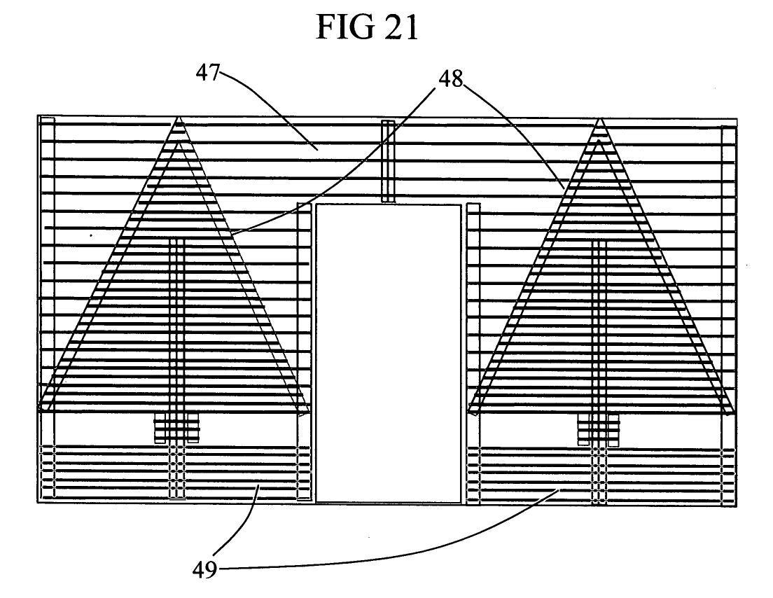

FIG. 21 shows the wall (52) after decorative lighting has been applied to impart a design consisting of blue-sky background (47), 2 green Christmas tree shaped objects (48) and white snow cover (49).

An additional simple embodiment for a cylindrical modified cylindrical or branched object consists of a single decorative lighting spine affixed parallel to the cylindrical axis of the object as well as additional axes that exist on branched objects. One or more strings of lights or LEDs would be woven back and forth from the spine. The spine would ensure consistent spacing of the desired width between parallel rows of lights and enable the user to string the lights without having to encircle the object.

An additional simple embodiment is offered by utilizing the submitted version of the decorative lighting attachment spine that can be split apart and rejoined along its longitudinal axis. This embodiment allows a user to install a decorative lighting pattern on any of the types of cylindrical objects previously described is the same fashion as the previous embodiment. The completed design can then be removed from the decorated object by removing the decorative lighting attachment spine mating clips and splitting the decorative lighting attachment spine into two elements. The entire design assembly with the two decorative lighting attachment spine halves and the attached lights can then be rolled up and stored as desired. To reinstall the design, the design assembly is wrapped around the original object and the two spine halves are reattached with the decorative lighting attachment spine mating clips. This embodiment can be enhanced by using one or a plurality of decorative lighting attachment combs to ensure more consistent spacing around the circumference of the decorated object.

A complex embodiment for a cylindrical or a modified cylindrical shape is comprised of two or more spines affixed parallel to the axis of the object. Two spines in parallel would allow the user to only wrap a portion of the circumference of the object and thereby utilize a lesser number of lights and reduce energy consumption by only covering the portion of the object that is visible to the target audience. Three or more of any combination of spines and combs in parallel allow all advantages of 2 spines and enable the user to impart patterns such as squares, rectangles, triangles and the like. Patterns can be comprised of lit spaces versus unlit spaces and/or differing light bulb or LED colors or density.

In an additional preferred aspect, the attachment strips referred to as spines and alignment combs can be used in conjunction with branched cylindrical and modified cylindrical objects. In this aspect the main cylinder or trunk would have an alignment spine or a multitude of spines with or without alignment combs attached in the same manner as described in the previous aspect. Additionally, one or a multitude of spines and alignment combs would be attached to any branch where it is desired to continue the design pattern implemented on the trunk.

This aspect also includes the above simple and complex embodiment whereas the simple embodiment uses one alignment spine for each cylindrical or roughly cylindrical trunk or branch. The complex embodiment provides for the use of multiple spines and optional alignment combs on any or all of the trunk or branch portions of a decorated branched structure.

Another preferred aspect of the complex embodiment consists of using a multitude of spines and possibly alignment combs to afford decoration of less than the total circumference of the types of cylindrical objects described previously. This permits segmenting the attached lights into designs comprised of differentiation between lights and no lights or differing types or colors of lights. In addition, this aspect permits decorative lighting to be confined to the viewable portion of a decorated cylindrical object thus reducing the amount of lighting resources and power required to operate the attached lights.

Another preferred aspect is the use of attachment spines and alignment combs to permit attachment of decorative lights in a desired pattern on flat or planar forms such as walls and fences.

Another preferred aspect is the inclusion of optional wiring channel covers. The covers are defined in two styles. One style is used to fill in the void between the two sidewalls of attachment spines. The second style fits over the vertical prongs of the alignment combs. In both events, the benefits of the optional covers are two-fold. The covers serve as lighting shade to block the display from bulbs that might disrupt the desired lighting pattern and they can provide conduits for electrical power cords that might be necessary to provide power to additional strips of decorative lights.

All results described for 2 or 3 or more parallel spines and/or combs can be accomplished on planar or curved surfaces as well.

In operation, the desired decorative strips are emplaced as desired on the selected object or surface. The decorative strips can be affixed in either a permanent or temporary fashion. For extended lengths a multitude of decorative lighting attachment strips can be joined together via molded attachment prongs. Strings of decorative Lights or LEDs are then woven to and fro between the desired combination of strips to affect the desired result. While installation of decorative lighting strips and lights may require a ladder or some other device to enable installer access, the amount of time required upon such a device will be significantly reduced over other methods that produce equivalent results. Removal of installed strings of lights or LEDs can be accomplished from the ground as the strings are held in place by friction and simple loops around the spine protuberances rather than mechanical fasteners contrivances of any sort. A multitude of decorative lighting strips and their attachment methods may be used to decorate a multitude of objects or surfaces.

### REFERENCES

U.S. Pat. No. 6,832,842 Sullivan Dec. 21, 2004 362/237
U.S. Pat. No. 6,693,391 Ahroni Feb. 17, 2004 315/185
U.S. Pat. No. 6,224,232 Rodriguez May 1, 2001 362/145
U.S. Pat. No. 6,224,231 Personius May 1, 2001 362/123
U.S. Pat. No. 6,203,171 Sherman, Jr. Mar. 20, 2001 362/249
U.S. Pat. No. 6,183,104 Ferrara Feb. 6, 2001 362/145
U.S. Pat. No. 6,050,709 Hastings Apr. 18, 2000 362/365
U.S. Pat. No. 6,485,161 Whitaker, et al. Nov. 26, 2002 362/249
U.S. Pat. No. 6,139,168 Gary, et al. Oct. 31, 2000 362/252
U.S. Pat. No. 5,594,628 Reuter, et al. Jan. 14, 1997 362/249

What we claim is:

1. A decorative lighting mounting mechanism, used for cylindrical, planar and curved surfaces comprising:
a plurality of decorative lighting attachment spines;
a plurality of decorative lighting alignment combs;
a plurality of decorative lighting alignment combs and attachment spines;
a plurality of attachment spine covers used in conjunction with said decorative lighting attachment spines;
a plurality of decorative spine mating clips positioned adjoining to said decorative lighting attachment spines

2. The mechanism of claim 1, wherein said lighting alignment spine is a flexible channel slotted and angled on 2 sides to allow positioning of said decorative lighting strings.

3. The mechanism of claim 1, whereas the 3-piece decorative lighting attachment spine may be disassembled to allow removal and preservation of an implemented lighting design for re-use.

4. The mechanism of claim 1 whereby a plurality of spines and combs may be used to hold a multitude of light layers in place. This allows alternating or sequential patterns to be displayed by the use of electrical timers or sequencers.

5. The mechanism of claim 1 whereby a plurality of spines and combs may be used to impart geometric designs on cylindrical shapes.

6. The mechanism of claim 1 whereby a plurality of spines and combs may be used to wrap lights around the visible a portion of the circumference of a cylindrical without applying lights to the non-viewable portion of the object resulting in the use of less lights and less energy.

7. The mechanism of claim 1 wherein the optional lighting alignment comb is a flexible T shaped channel slotted to provide alignment of decorative lighting strings.
